(19) United States
(12) Patent Application Publication
(10) Pub. No.: US 2024/0343312 A1
(43) Pub. Date: Oct. 17, 2024

(54) Plastic Component for a Motor Vehicle, Component Assembly for a Motor Vehicle, Method for Producing a Plastic Component for a Motor Vehicle, and Method for Producing a Component Assembly for a Motor Vehicle

(71) Applicant: Bayerische Motoren Werke Aktiengesellschaft, Muenchen (DE)

(72) Inventors: Michael BECHTOLD, Landshut (DE); Thomas GERBER, Tiefenbach (DE); Andreas HUBER, Schoenberg (DE)

(21) Appl. No.: 18/293,807

(22) PCT Filed: Jul. 14, 2022
(86) PCT No.: PCT/EP2022/069727

§ 371 Date: Jan. 31, 2024

(30) Foreign Application Priority Data
Aug. 24, 2021 (DE) 10 2021 121 848.9

(51) Int. Cl. B62D 27/06; B62D 25/06; B62D 27/02; B62D 29/00; B62D 29/04

(52) U.S. Cl. CPC B62D 27/06; B62D 25/06; B62D 27/026; B62D 29/005; B62D 29/043

(57) ABSTRACT

A plastic component for a motor vehicle includes a main body. The main body has a matrix material. The main body also has at least one fastening portion which is configured to mount on a vehicle component. At least one magnet is also incorporated into the matrix material being provided in the fastening portion.

### BACKGROUND AND SUMMARY

The disclosure relates to a plastic component for a motor vehicle, to a component assembly for a motor vehicle, to a method for producing a plastic component for a motor vehicle, and to a method for producing a component assembly for a motor vehicle.

Within the context of lightweight construction, plastic components are being used increasingly in motor vehicles. Here, fiber-reinforced plastic components are also being used increasingly. If fiber-reinforced plastic components are used in the region of the vehicle body, hybrid material pairings frequently occur when the fiber-reinforced plastic components are assembled with metallic parts of the vehicle body to form a component assembly. An adhesive bond is usually used here. Positionally accurate fixing of the components to be connected and handling stability have to be ensured here until the final curing of the adhesive.

This is usually ensured by way of local mechanical connections such as, for example, screw connections or rivet connections. Using the example of a CFRP vehicle roof, this is screwed at four or six positions to the vehicle frame, for example. This is associated with high costs. In addition, installation space has to be made available, and a satisfactory mounting accessibility can be realized only with difficulty.

Against this background, it is the object of the disclosure to specify a possibility as to how the mounting capability of a plastic component for a motor vehicle can be improved; in particular, the solution is intended to make simple mounting which is associated with low costs possible.

The object is achieved by way of a plastic component for a motor vehicle according to the present disclosure, a component assembly for a motor vehicle according to the present disclosure, a method for producing a plastic component according to the present disclosure, and a method for producing a component assembly according to the present disclosure. Further advantageous refinements result from the following description.

A plastic component for a motor vehicle is specified with a main body which has a matrix material. In one preferred refinement, the plastic component is a fiber-reinforced plastic component; then, furthermore, the main body has a fiber reinforcement which is incorporated into the matrix material. The fiber reinforcement can be present in the form of short, long or endless fibers which are incorporated into the matrix material in an ordered or orderless form. For example, carbon fibers, glass fibers, aramid fibers, natural fibers or metal fibers which can also be used in combination with one another are suitable as reinforcement fibers. In order to achieve particularly high strengths as are desirable, for example, for vehicle body components, the fiber reinforcement can preferably be present in the form of aligned endless fibers, for example as a roving, a woven fabric or a mesh. These can be arranged, in particular, as a stack of a plurality of fiber layers layered above one another in the matrix material. In particular, thermosets and also thermoplastics are suitable as matrix material.

The main body preferably substantially forms the outer shape of the plastic component or the fiber-reinforced plastic component. The main body has at least one fastening portion which is configured for mounting on a vehicle component. To this end, the fastening portion can be, for example, of flange-like configuration, can be recessed in comparison with the remaining main body, or can have a different thickness than the remaining main body. According to the disclosure, at least one magnet which is also incorporated into the matrix material is then provided in the fastening portion.

The disclosure proceeds from the consideration of already integrating a fixing means for mounting into the plastic component or the fiber-reinforced plastic component. As a result of the integrated magnet, the plastic component or the fiber-reinforced plastic component can be positioned on a steel vehicle component and adheres by itself to the latter, without a further fixing being necessary. In this way, screw connections or rivet connections which have been necessary up to now to ensure the handling stability can be dispensed with. In addition, the integration of a magnet does not require any significant installation space. The mounting is considerably simple, since it is sufficient if the plastic component or the fiber-reinforced plastic component is deposited on the vehicle component in a locationally and positionally accurate manner. The fixing takes place automatically by way of the magnet.

The at least one magnet is preferably integrated completely into the plastic component or the fiber-reinforced plastic component and is covered with matrix material. As a result, the continuous plastic surface of the component is retained, which facilitates subsequent adhesive bonding and avoids possible corrosion issues.

In order to secure the plastic component or the fiber-reinforced plastic component against unintentional rotation, it can be advantageous in one refinement if two or more magnets are provided in the fastening portion. For example, they can be distributed uniformly over the fastening portion or they can be arranged in corners of the fastening portion.

In the case of extensive plastic components or extensive fiber-reinforced plastic components such as, for example, a vehicle roof, it can be advantageous if, in one refinement, a multiplicity of magnets which are spaced apart from one another are provided in the fastening portion. Here, a “multiplicity” is to be understood to mean a number of 10 magnets or more and, in particular, 20 magnets or more. The use of a multiplicity of magnets makes it possible for the size of each individual magnet to be reduced. It can be provided, for example, that the cross section of each magnet, in relation to the connecting plane, is less than 100 mm², less than 50 mm² and, in particular, less than 25 mm². Magnets which are as small as this can be integrated simply into the fiber composite material. Magnets which are as small as this also bring about virtually no laminate weakening, for which reason the use of a multiplicity of magnets has proven advantageous, in particular, when the fiber-reinforced plastic component is a vehicle body component.

The number, type and size of the magnets are preferably selected in a manner which is dependent on the nature of the plastic component or the fiber-reinforced plastic component, of the vehicle component and the mounting situation in such a way that the plastic component or the fiber-reinforced plastic component is fixed reliably on the vehicle component by way of the magnetic force, and the required handling stability (handling strength) is ensured. It is preferred if permanent magnets are used as magnet or magnets. On account of the high energy density with at the same time a low price, the use of neodymium iron boron magnets (“neodymium” magnets colloquially) is particularly preferred.

Furthermore, a component assembly for a motor vehicle is specified with a vehicle component which has at least one ferromagnetic portion, and an above-described plastic component or fiber-reinforced plastic component. In the component assembly, the plastic component or the fiber-reinforced plastic component adheres magnetically to the vehicle component. Furthermore, the fastening portion of the plastic component or the fiber-reinforced plastic component is adhesively bonded to the vehicle component. The magnetic connection between the plastic component or fiber-reinforced plastic component and the vehicle component serves here merely for positionally accurate fixing of the two components to one another until the adhesive is cured. The actual connecting strength of the component assembly is ensured via the adhesive bond.

It is preferred in one refinement if the vehicle component is a steel sheet component. Steel sheets which are ferromagnetic are usually used for vehicle components. If this is the case, the magnet can adhere to the entire vehicle component. It is not necessary for individual regions of the vehicle component to be prepared or treated separately, with the result that there is particularly simple and inexpensive production of the component assembly.

It is provided in an alternative refinement that the vehicle component is configured from a light metal or plastic, preferably with fiber reinforcement. In this refinement, a ferromagnetic additional component which forms the at least one ferromagnetic portion is attached to the vehicle component, furthermore. The additional component can, for example, be adhesively bonded to the vehicle component or can be incorporated into the plastic. This refinement makes it possible for the advantages of simple positioning and fixing to be used even in the case of a component assembly of components made from non-ferromagnetic basic materials.

In one refinement, the fiber-reinforced plastic component forms a local reinforcement of a vehicle component. To this end, the fiber-reinforced plastic component can preferably be configured in the manner of a patch or vamp. It is then applied in a portion of the vehicle component which has to satisfy particular mechanical loads. The fiber-reinforced plastic component is preferably a vehicle body component such as, for example, a vehicle pillar.

In a further refinement, the fiber-reinforced plastic component itself forms a vehicle body component such as, for example, a vehicle roof. As a result of the integrated magnets, it then also becomes possible according to the disclosure for fiber-reinforced vehicle body components which are extensive in this way to be fixed on further vehicle body components in a simple and secure way until the adhesive bond is cured.

Furthermore, a method for producing a plastic component for a motor vehicle is specified. The method comprises the steps: producing a main body with a matrix material, and introducing at least one magnet into a fastening portion of the main body, with the result that the magnet is incorporated into the matrix material.

In one preferred refinement, a fiber-reinforced plastic component is produced by way of the method, to which end a main body is produced with a fiber reinforcement which is incorporated into a matrix material.

Here, the production of the main body is not restricted to certain methods. Production can take place, for example, using the injection molding method, using the RTM method or by way of wet pressing. The at least one magnet is preferably already integrated into the main body during the production of the latter, by, for example, already being arranged in the semifinished fiber product or in the mold when the matrix material cures or cools down.

Furthermore, a method for producing a component assembly is specified, the component assembly having a vehicle component and a plastic part or fiber-reinforced plastic part according to the disclosure. The method for producing the component assembly comprises the steps:
providing the vehicle component which has at least one ferromagnetic portion,
arranging the plastic component or the fiber-reinforced plastic component on the first component such that the at least one magnet of the plastic component or the fiber-reinforced plastic component adheres to the ferromagnetic portion of the vehicle component,
arranging an adhesive layer between the fastening portion of the plastic component or the fiber-reinforced plastic component and the vehicle component, and
curing the adhesive layer in order to configure an adhesive bond between the vehicle component and the plastic component or the fiber-reinforced plastic component.

The adhesive is preferably applied to the plastic component or the fiber-reinforced plastic component and/or the vehicle component before they are moved toward one another and adhere to one another as a result of the magnetic force. Since the two components are fixed securely on one another by way of the magnets and the required handling stability is ensured, further mounting steps can follow directly, even if the adhesive is not yet completely cured at this time. This firstly makes lower cycle times possible, and secondly particularly inexpensive adhesives can be used such as, for example, single-component adhesives which have a relatively long curing time.

Features and details which are described in conjunction with the plastic component or the fiber-reinforced plastic component or the component assembly also apply in conjunction with the methods according to the disclosure and in each case vice versa, with the result that reference is always made or can always be made mutually with regard to the disclosure in respect of the individual aspects of the disclosure.

Further advantages, features and details of the disclosure result from the following description, in which exemplary embodiments of the disclosure are described in detail with reference to the drawings. Here, the features which are mentioned in the claims and in the description can be essential to the disclosure in each case individually per se or in any desired combination. If the term “can” is used in this application, this is both the technical possibility and the actual technical implementation.

In the following text, exemplary embodiments will be explained on the basis of the appended drawings, in which, in a diagrammatic illustration:

### BRIEF DESCRIPTION OF THE DRAWINGS

FIG. 1 shows an exemplary fiber-reinforced plastic component,

FIG. 2 shows an exemplary fiber-reinforced plastic component and a vehicle component for producing a component assembly,

FIG. 3 shows an exemplary component assembly in a plan view and a sectional view A-A, and

FIG. 4 shows a further exemplary component assembly in a sectional view.

### DETAILED DESCRIPTION OF THE DRAWINGS

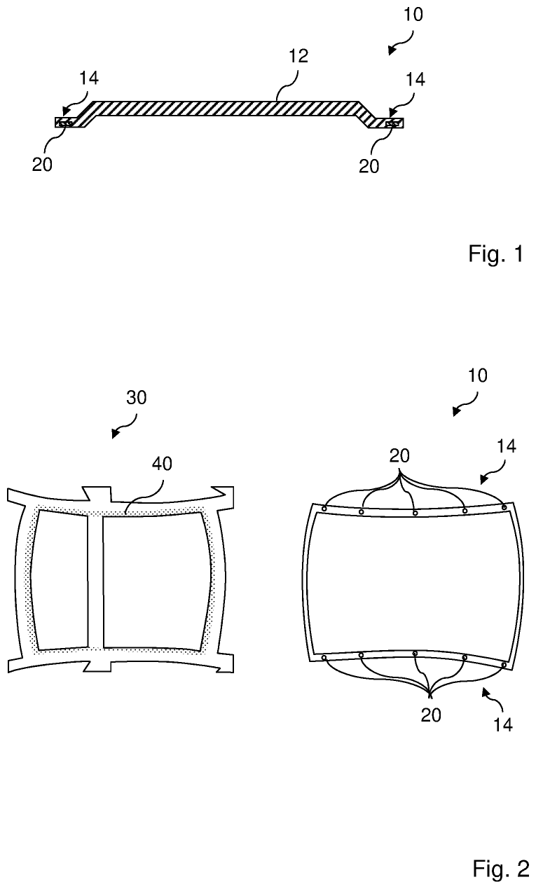

FIG. 1 shows an exemplary fiber-reinforced plastic component 10 in a diagrammatic sectional view. The fiber-reinforced plastic component 10 has a main body 12 which is made from a fiber composite material which has a fiber reinforcement which is incorporated into a matrix material. The fiber-reinforced plastic component 10 is by way of example a vehicle roof. On the edge side, the main body 12 has a fastening portion 14 which is configured (here, as a flange by way of example) for fastening the fiber-reinforced plastic component 10 to a vehicle component. A plurality of magnets 20 which are integrated into the main body 12 and are incorporated completely into the matrix material are arranged in the fastening portion 14.

FIG. 2 shows the fiber-reinforced component 10 from FIG. 1 in a plan view, and a vehicle component 30 in the form of a roof frame. Ten magnets 20 are provided by way of example in the fastening portion 14 of the fiber-reinforced plastic component 10. The vehicle component 30 is configured as a steel sheet component made from a ferromagnetic steel. In order to produce a component assembly, the fiber-reinforced component 10 in the form of the vehicle roof is adhesively bonded onto the vehicle component 30. The region of the adhesive bond is indicated as a dotted area 40. During mounting, the fastening portion 14 of the fiber-reinforced plastic component 10 will come to lie in this region. The adhesive is applied to the fiber-reinforced plastic component 10 and/or the vehicle component 30. The fiber-reinforced plastic component 10 is then positioned in a locationally correct manner with respect to the vehicle component 30 and is deposited on the latter. The magnets 20 fix the fiber-reinforced plastic component 10 via the magnetic holding force on the vehicle component 30, and establish the handling stability. Since the magnets 20 prevent the components 10 and 30 from being displaced with respect to one another, further mounting steps can take place while the adhesive is curing.

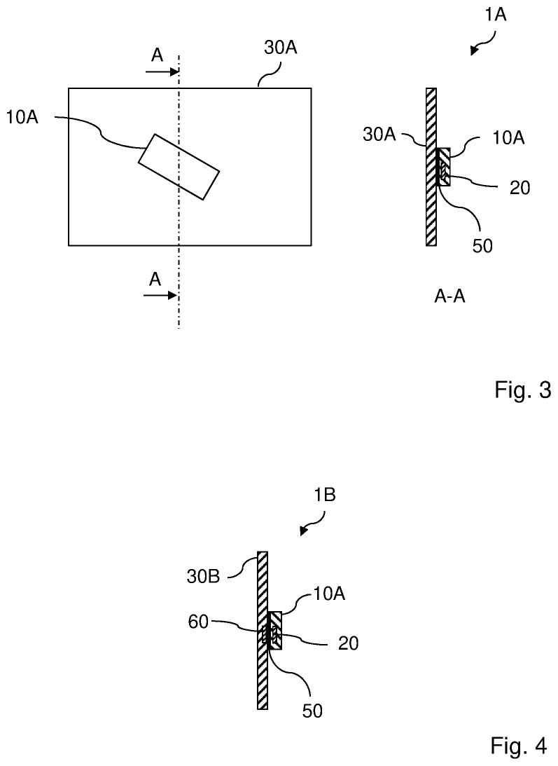

FIG. 3 shows an exemplary component assembly 1A in a plan view and a sectional view A-A. The component assembly 1 has a vehicle component 30A in the form of a steel sheet component, onto which a plastic component 10A is adhesively bonded. The plastic component 10A is adhesively bonded to the vehicle component 30 over the full surface area by way of the adhesive layer 50. In this exemplary embodiment, the fastening portion as a result extends over the entire area of the plastic component 10A. On account of the small size of the local reinforcement, a single magnet 20 is sufficient in the case of this exemplary embodiment. The plastic component 10A can be configured with or without fiber reinforcement. If the plastic component 10A is intended to serve as local reinforcement of a vehicle body component, it is preferably configured as a fiber-reinforced plastic component.

FIG. 4 shows a further exemplary component assembly 1B in a diagrammatic sectional view. In contrast to the component assembly 1A from FIG. 3, the (fiber-reinforced) plastic component 10A is applied here to a vehicle component 30B which is formed from a non-ferromagnetic material. The vehicle component 30B can be configured, for example, from a light metal such as, for example, aluminum or magnesium, or as a fiber-reinforced plastic component. In order to nevertheless make the above-described fixing by means of the magnet 20 possible, a ferromagnetic additional component 60 which can be integrated into the component is provided in the vehicle component 30B. For example, the additional component 60 can be adhesively bonded or clamped into a depression, or the additional components 60 can be integrated in a similar manner to the magnet 20 into a fiber composite body.

### LIST OF DESIGNATIONS

1A, 1B Component assembly
10, 10A (Fiber-reinforced) plastic component
12 Main body
14 Fastening portion
20 Magnet
30, 30A, 30B Vehicle component
40 Region of the adhesive bond
50 Adhesive layer
60 Ferromagnetic additional component

1.-13. (canceled)

14. A plastic component for a motor vehicle comprising:
a main body which has a matrix material, the main body having at least one fastening portion which is configured to mount on a vehicle component, and at least one magnet which is also incorporated into the matrix material and that is provided in the fastening portion.

15. The plastic component according to claim 14, wherein the plastic component is fiber-reinforced, and the main body further comprises a fiber reinforcement which is incorporated into the matrix material.

16. The plastic component according to claim 15, wherein two or more magnets are provided in the fastening portion.

17. The plastic component according to claim 16, wherein a multiplicity of magnets which are spaced apart from one another are provided in the fastening portion.

18. The plastic component according to claim 17, wherein the at least one magnet is a permanent magnet.

19. A component assembly for a motor vehicle with a vehicle component which has at least one ferromagnetic portion, and a plastic component according to claim 18, wherein the plastic component is adhered magnetically to the vehicle component, and the fastening portion of the plastic component is adhesively bonded to the vehicle component.

20. The component assembly according to claim 19, wherein the vehicle component is a steel component.

21. The component assembly according to claim 19, wherein the vehicle component is configured from a light metal or plastic with or without fiber reinforcement, and the at least one ferromagnetic portion is formed by way of a ferromagnetic additional component.

22. The component assembly according to claim 21, wherein the plastic component is a fiber-reinforced plastic component, and the vehicle component is a vehicle body component, and the plastic component forms a local reinforcement of the latter.

23. The component assembly according to claim 22, wherein the plastic component is a fiber-reinforced plastic component, and the vehicle component and the plastic component are each vehicle body components.

24. A method for producing a plastic component for a motor vehicle, comprising:
producing a main body with a matrix material, and
introducing at least one magnet into a fastening portion of the main body, such that the magnet is incorporated in the matrix material.

25. The method for producing a plastic component according to claim 24, wherein the plastic component is a fiber-reinforced plastic component, to which end the main body is produced with a fiber reinforcement which is incorporated into the matrix material.

26. A method for producing a component assembly, the component assembly having a vehicle component and a plastic component according to claim 18, comprising:
providing the vehicle component which has at least one ferromagnetic portion;
arranging the plastic component on the vehicle component such that the at least one magnet of the plastic component adheres to the ferromagnetic portion of the vehicle component;
arranging an adhesive layer between the fastening portion of the plastic component and the vehicle component; and
curing the adhesive layer in order to configure an adhesive bond between the vehicle component and the plastic component.
